(19) United States
(12) Patent Application Publication
(10) Pub. No.: US 2009/0029131 A1
(43) Pub. Date: Jan. 29, 2009

(54) OPTICAL THIN SHEET HAVING REINFORCED STRUCTURE

(76) Inventors: Mao-Jung YEH, Kaohsiung (TW); Chin-Mu Lee LEE, Kaohsiung (TW); Chun-Hsiung CHANG, Kaohsiung (TW)

Correspondence Address: LADAS & PARRY LLP, 26 WEST 61ST STREET, NEW YORK, NY, 10023, US

(21) Appl. No.: 12/245,294

(22) Filed: Oct. 3, 2008

(30) Foreign Application Priority Data
May 10, 2007 (TW) 096137631

(51) Int. Cl. B32B 7/02; B32B 17/06; B32B 27/36; B32B 27/32; B32B 27/06; B32B 27/38; B32B 17/10; B32B 27/08

(52) U.S. Cl. 428/215; 428/426; 428/480; 428/412; 428/523; 428/473.5; 428/337; 428/336; 428/413; 428/441; 428/430; 428/417; 428/483; 428/516; 428/421; 428/422

(57) ABSTRACT

The invention provides an optical thin sheet having a reinforced structure, comprising a substrate and at least one protective layer, said protective layer formed on at least one of the surfaces of the substrate and comprising an organic layer, wherein the organic layer comprises a thermosetting resin and is used to enhance the toughness of the substrate. There is good adhesion between the protective layer and the substrate. The optical thin sheet protected by the protective layer of the invention does not wrap and possesses high transparency.

### TECHNICAL FIELD

The subject invention relates to an optical thin sheet, particularly an optical thin sheet having a reinforced structure.

### PRIOR ART

Currently, light-weight and small-size electronic products are being developed. Since a cathode ray tube (CRT) cannot meet the requirements for light weight, small size, and lower power consumption, it has been gradually replaced by liquid crystal display (LCD), plasma display panel (PDP), electroluminescent display (ELD), and vacuum fluorescent display, among which the LCD has become the most popular product for good picture quality, low radiation, low power consumption, and better space efficiency.

To obtain small and light LCD, a possible approach is to reduce the weight of the glass substrate or replace the glass substrate with a plastic one. However, if a glass substrate is replaced with a plastic one, the high temperature in the production of the display and the properties of the plastic should be taken into consideration. Typically, it is necessary to coat the plastic substrate with a protective layer. Therefore, there is a need in the industry to find a solution to retain the transparency of the substrate itself, to enhance the toughness of the substrate, to avoid the warp of the substrate caused by the uneven stress or inconsistent shrinkage rate of the curable resin in the protective layer during the curing process, and to ensure good adhesion between the protective layer and the substrate.

In addition, the thickness of a glass substrate can be reduced by an etching method. However, the glass substrate may crack under an uneven force and the production yield thereof will be poor. Given this, U.S. Pat. No. 6,327,011 B2 discloses a thin glass substrate for liquid crystal display devices comprising a glass substrate and a protective layer on the back surface of the substrate, wherein the protective layer comprises an organic layer and inorganic layer and is used for reinforcing the glass substrate and avoiding cracks caused by external force. However, although the incorporation of an inorganic layer may enhance the adhesion between the protective layer and the glass substrate, the transparency of the substrate will become poor. Moreover, the incorporation of an inorganic layer necessitates additional processing step and may reduce the production yield.

### SUMMARY OF THE INVENTION

The primary object of the present invention is to provide an optical thin sheet having a reinforced structure by utilizing a protective layer to improve the toughness and yellowing resistance of the thin sheet, to retain the transparency of the thin sheet, and to simultaneously ensure the good adhesion between the protective layer and the substrate of the thin sheet and avoid the warp of the thin sheet that may be caused by the non-uniform shrinkage rate and uneven stress of the curable resin in the protective layer during the curing process.

In order to achieve the above and other purposes, the invention provides an optical thin sheet having a reinforced structure, comprising a substrate and at least one protective layer on at least one of the surfaces of the substrate, wherein said at least one protective layer comprises at least one organic layer comprising a thermosetting resin and a curing agent.

### DETAILED DESCRIPTION OF THE INVENTION

The substrate used in the inventive optical thin sheet can be any kind of substrate known to those having ordinary skill in the art, such as glass or plastic. The plastic substrate is not particularly limited and includes, for example, but is not limited to, a polyacrylate resin, such as polymethyl methacrylate (PMMA); a polycarbonate resin; a polystyrene resin; a polycycloolefin resin; a polyolefin resin, such as polyethylene (PE) or polypropylene (PP); a cellulose acetate resin; a polyimide resin; a polyester resin, such as polyethylene terephthalate (PET); or a mixture thereof. The thickness of the substrate is preferably less than 1 mm and more preferably in the range from 0.1 to 0.6 mm, usually depending on the desired purpose of an optical product.

In order to enhance the toughness of the substrate, the substrate is provided with a protective layer on at least one of the surfaces thereof. The protective layer can be formed by any conventional method, which is, for example, but not limited to, coating, adhesion, vapor-deposition, or spray-deposition, and preferably by a coating method.

In order to retain the original transparency of the substrate, the protective layer preferably possesses a refractive index equivalent to that of the substrate, such as in the range from 1.4 to 1.6. Moreover, by properly adjusting the shrinkage rate of the organic layer of the protective layer to be substantially the same as or similar to that of the substrate, the warp problem associated with the substrate can be solved. In addition, in order to reduce the cost and control the quality of the optical thin sheet, the organic layer preferably possesses a thickness in the range from 1 μm to 20 μm, more preferably in the range from 5 μm to 15 μm, and most preferably in the range from 8 μm to 12 μm.

The optical thin sheet of the invention comprises at least one organic layer comprising (a) a thermosetting resin and (b) a curing agent. Suitable species of the thermosetting resin used in the organic layer include, but are not limited to, a polystyrene resin, a polyester resin, an epoxy resin, a fluorocarbon resin, a polyacrylate resin, and a polycarbonate, or a mixture thereof, among which the fluorocarbon resin and polyacrylate resin are preferred. By utilizing a thermosetting resin, the invention can solve the warp and deformation problems associated with the substrate coated with a curable resin, caused by an extremely large internal stress due to the rapid curing rate of the curable resin, and can impart the resultant thin sheet with a high strength and good toughness and heat resistance. Since the thermosetting resin has a high solids content with a relatively small amount of solvent, the coated substrate can be baked in a shortened period and at a lower temperature without suffering from the volume shrinkage phenomenon due to the evaporation of a large amount of solvent. Typically, the thermosetting resin can be cured at a temperature of from about 25° C. to 150° C., thereby further reducing the operation cost. The thermosetting resins suitable for the present invention normally possess an average molecular weight in the range from about 10⁴ to about 2×10⁶, preferably from about 2×10⁴ to about 3×10⁵, and more preferably from about 3×10⁴ to about 10⁵. Specifically, the thermosetting resin is derived from a monomer mixture comprising the following monomers:

a monomer (a1) having at least one thermally curable functional group that does not react with the curing agent (b), said functional group being selected from the group consisting of hydroxy, vinyl, amido, urethano, epoxy, and carbonyl, and a mixture thereof, and
a monomer (a2) having at least one functional group that can react with the curing agent (b), said functional group being selected from the group consisting of hydroxy, carboxyl, amino, and epoxy, and a mixture thereof.

The main chain of the thermosetting resin used in the present invention is composed of at least one (a1) monomer. Different thermosetting resins utilize different (a1) monomers. For example, in an embodiment of the invention, a polyacrylate resin is chosen as the thermosetting resin whose (a1) monomer comprises at least one acrylate monomer having the following general formula:

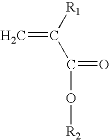

wherein R₁ is hydrogen or methyl; and R₂ is hydrogen, a C₆-C₁₈ aromatic group, a C₁-C₁₈ aliphatic group, or a C₂-C₄ epoxy group. Preferably, the acrylate monomer used in the present invention is (meth)acrylic acid, methyl (meth)acrylate, ethyl (meth)acrylate, (iso-)butyl (meth)acrylate, isooctyl (meth)acrylate, cyclohexyl (meth)acrylate, or glycidyl (meth)acrylate, or a mixture thereof.

According to another embodiment of the present invention, the thermosetting resin is a fluorocarbon resin, which has good heat resistance. The (a1) monomer used to form the fluorocarbon resin comprises at least one fluorine-containing monomer. Suitable fluorine-containing monomers are well known to persons having ordinary skill in the art, and include, for example, but are not limited to, tetrafluoroethylene, hexafluoropropylene, chlorotrifluoroethylene, vinylidene fluoride, fluoroethylene, and difluoroethylene, and a mixture, among which chlorotrifluoroethylene is preferred.

The monomer (a2) used in the present invention must contain a functional group that can react with the curing agent (b) so that the main-chain molecules can be crosslinked to form a net structure. The functional group is selected from the group consisting of hydroxy (—OH), carboxyl (—COOH), amino (—NH₂), and epoxy, and a mixture thereof, among which hydroxy (—OH) is preferred. According to the present invention, suitable (a2) monomers include, for example, but are not limited to, hydroxyethyl (meth)acrylate, hydroxypropyl (meth)acrylate, hydroxybutyl vinyl ether, and 2-hydroxyethyl methacrylate and a mixture thereof.

To enhance the stress buffering ability, the adhesion between the protective layer and the substrate, and the internal stress plasticity, and to obviate the warp defects of a substrate (particularly, for a glass substrate, and more particularly, for a glass substrate with a thickness less than 1 mm), the monomer mixture for the thermosetting resin optionally comprises a monomer (a3) selected from a tertiary carboxylic ester, a vinyl ether monomer, vinyl acetate monomer, styrene monomer, or a mixture thereof.

The vinyl ether monomers suitable for the present invention are not particularly limited and include, for example, but are not limited to, C₂-C₁₁alkyl vinyl ether monomers, which can be selected from straight chain alkyl vinyl ether monomers, branched alkyl vinyl ether monomers, cycloalkyl vinyl ether monomers, or a mixture thereof. Preferably, the vinyl ether monomer used in the present invention is cyclohexyl vinyl ether or ethyl vinyl ether, or a combination thereof.

The tertiary carboxylic esters suitable for the present invention are represented by the following general formula:

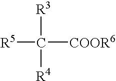

wherein R₃, R₄, and R₅ independently represent a straight chain or branched alkyl of the formula CₘH₂ₘ₊₁ in which m is an integer of from 1 to 7, and preferably, the sum of the carbon atom numbers of R₃, R₄, and R₅ is from 9 to 11, and R₆ is selected from the group consisting of:

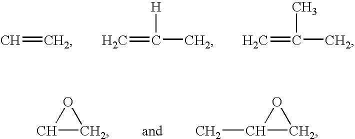

among which

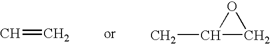

is preferred. Preferably, the tertiary carboxylic ester is selected from the group consisting of vinyl tertiary decanoate, vinyl tertiary nonanoate, and epoxy propyl tertiary decanoate, and a mixture thereof.

The use of monomer (a3) does not require special limitation. However, for better effectiveness, a certain thermosetting resin can be used in combination with a certain monomer (a3). For example, a polyacrylate resin can be used in combination with a tertiary carboxylic ester monomer or vinyl acetate monomer or a mixture of these monomers, and preferably with a tertiary carboxylic ester monomer; and a fluorocarbon resin can be used in combination with a vinyl ether monomer.

The curing agent (b) used in the present invention is well known to persons having ordinary skill in the art. The curing agent possesses at least one functional group that can react with the monomer (a2) in the protective layer, so as to form a crosslinking through the chemical bonding between the molecules. The functional group is selected from the group consisting of isocyanato (—NCO), hydroxy, carboxyl, an ester group, an anhydride group, and an amino group (—NH₂ or —NHR), and a mixture thereof, among which isocyanato is preferred. By any currently feasible process, a polyisocyanate having at least one free isocyanato group can be prepared. For example, a mono-isocyanate, diisocyanate, or triisocyanate with functional groups can be used. Suitable diisocyanates and triisocyanates include, but are not limited to, hexamethylene diisocyanate (HDI), 1,4-cyclohexane diisocyanate (CHDI), toluene diisocyanate (TDI), 4,4′-diphenylmethane diisocyanate (MDI), isophorone diisocyanate (IPDI), 1,6-hexane diisocyanate trimer, and isophorone diisocyanate trimer.

According to a preferred embodiment of the present invention, the inventive optical thin sheet having reinforced structure comprises a glass substrate with a thickness less than 1 mm; and a protective layer coated on a surface of the substrate, wherein said protective layer is composed of an organic layer with a thickness of 5 μm to 15 μm and preferably with a refractive index of from 1.4 to 1.6, where the organic layer comprises (a) a polyacrylate resin and (b) a curing agent having an isocyanato group, preferably, a diisocyanate, wherein the optical thin sheet possesses a light transmittance of 90% or more, as determined according to JIS K7136 standard method; and wherein said polyacrylate resin is derived from a monomer mixture comprising the following monomers:

Monomer (a1) selected from the group consisting of (meth)acrylic acid, methyl (meth)acrylate, ethyl (meth)acrylate, (iso-)butyl (meth)acrylate, and a mixture thereof, and
Monomer (a2) having a hydroxy group that can react with the curing agent (b), preferably, monomer (a2) selected from the group consisting of hydroxyethyl (meth)acrylate, hydroxypropyl (meth)acrylate, and 2-hydroxyethyl methacrylate and a mixture thereof.
The above monomer mixture may further comprise monomer (a3) of a tertiary carboxylic ester monomer as defined hereinbefore.

The protective layer according to the present invention may optionally include any additives known to persons having ordinary skill in the art, which include, but are not limited to, an anti-static agent, a fluorescent agent, a UV light absorbent, a leveling agent, an initiator, a promoter, a solvent, a wetting agent, a stabilizing agent, and a dispersant.

The anti-static agents useful in the present invention are not particularly limited and are well known to persons of ordinary skill in the art, which include, for example, ethoxy glycerin fatty acid esters, quaternary amine compounds, aliphatic amine derivatives, epoxy resins (such as polyethylene oxide), siloxane, or other alcohol derivatives, such as poly(ethylene glycol) ester, poly(ethylene glycol) ether and the like. According to an embodiment of the present invention, the inventive optical thin sheet has a surface resistivity in the range from about 10⁸ to about 10¹² Ω/□ (Ω/□ represents ohm/square).

The UV light absorbents useful in the present invention are not particularly limited and are well known to persons having ordinary skill in the art, which include, for example, benzotriazoles, benzotriazines, benzophenones, and salicylic acid derivatives; or UV absorbing inorganic particulates, such as zinc oxide, silicon dioxide, titanium dioxide, alumina, calcium sulfate, barium sulfate, calcium carbonate or a mixture thereof. The size of the inorganic particulates described above is usually in the range of 1-100 nanometers, preferably 20-50 nanometers.

The fluorescent agents useful in the protective layer of the inventive optical thin sheet are not particularly limited and are well known to persons having ordinary skill in the art, which can be organics including, for example, benzoxazoles, benzimidazoles, and diphenylethylene bistriazines.

According to an embodiment of the present invention, an organic layer is coated on a substrate as a protective layer. The organic layer useful for the invention comprises a two-pack type thermosetting resin, which can be coated onto a substrate by any method known to persons having ordinary skill in the art. For example, the inventive optical thin sheet can be produced by the process including the following steps:

(I) mixing monomer (a1), monomer (a2), and optional monomer (a3), and optionally a conventional additive (such as a solvent, an initiator, and so on) and allowing the mixture to react at an appropriate temperature for several hours so as to form a copolymer;

(II) adding a curing agent and optional a conventional additive (such as a solvent, a promoter, and so on) to the resultant copolymer so as to form a coating which was then coated on a substrate as a protective layer; and

(III) putting the coated substrate into a baking oven to evaporate the solvent and heating the substrate for several minutes at an elevated temperature above the curing point of the thermosetting resin to perform a thermal setting polymerization.

If necessary, the above steps can be repeated to obtain a plurality of protective layers.

The initiators useful for the above-mentioned step (I) are well known to persons having ordinary skill in the art, and include, for example, benzoyl peroxide, dicumyl peroxide, butyl peroxide, cumene hydroperoxide, t-butyl peroxymaleate, t-butyl peroxide, acetyl peroxide, lauroyl peroxide, azobisisobutyronitrile (AIBN), azobisisoheptyronitrile, a mixture of a peroxide, an amino acid or sulfonic acid, a mixture of a peroxide and a cobalt compound, and a mixture thereof, among which azobisisobutyronitrile is preferred.

The promoter useful for the above-mentioned step (II) is selected from the group consisting of methyl morpholine, ethyl morpholine, triethyl amine, dimethyl benzyl amine, dimethyl ethanol amine, ethylene diamine, dimethyl lauryl amine, dimethyl piperazine, triethylene diamine, tetramethyl ethylene diamine, tetramethyl hexamethylene diamine, 1,3,5-tridiaminomethyl phenol, 1,4-diaza-(2,2,2)bicyclooctane, hexamethyl triethylene tetramine, lead octoate, dibutyl tin dilaurirate, tin ethyl hexanoate, and zirconium octoate, among which dibutyl tin dilaurirate is preferred.

The species of the solvent useful for the present invention are not particularly limited and include, for example, a benzene compound, an ester, a ketone, or a mixture thereof. Non-limiting examples of the benzene solvent include benzene, toluene, xylene, trimethylbenzene, styrene, and a mixture thereof. Non-limiting examples of the ester solvent include ethyl acetate, butyl acetate, diethyl carbonate, ethyl formate, methyl acetate, ethoxyethyl acetate, ethoxypropyl acetate, and monomethyl ether propylene glycol acetate, and a mixture thereof. Non-limiting examples of the ketone solvent include acetone, butanone, methyl ethyl ketone, cyclohexanone, and methyl isobutyl ketone, and a mixture thereof.

In the above-mentioned step (II), the thermosetting resin can be directly coated on the substrate and it is not necessary to subject the substrate to additional surface treatment to enhance adhesion. Moreover, the suitable coating methods are well known to persons having ordinary in the art, which can be for example, slit die coating, micro gravure coating, or roller coating, or a combination thereof.

The protective layer of the inventive optical thin sheet possesses high strength and good toughness, and there is good adhesion between the protective layer and the substrate. Therefore, it is not necessary to introduce additional inorganic substance to enhance the strength and adhesion. Consequently, the optical thin sheet of the invention can have a better light transmittance of 90% or more, preferably from 90% to 99%, as determined according to JIS K7136 standard method. The optical thin sheet can be used in light source devices, for example, advertising light boxes or flat displays, in particular, in the panel or backlight module of a liquid crystal display (LCD). The optical thin sheet has a protective layer on the substrate surface and the protective layer can effectively enhance the toughness of the substrate and the surface thereof is level without warp, thereby avoiding the optical properties of the resultant thin sheet to be adversely affected.

The following examples are used to further illustrate the present invention, but not intended to limit the scope of the present invention. Any modifications or alterations that can easily be accomplished by persons skilled in the art fall within the scope of the disclosure of the specification and the appended claims.

### EXAMPLES

### Definitions of Abbreviations

MMA: methyl methacrylate

BA: butyl acrylate

2-HEMA: 2-hydroxypropyl methacrylate

MAA: methacrylic acid

Cardura E10: a trade name for a tertiary carboxylic ester (Hexion company, Singapore)

AIBN: azobisisobutyronitrile

CTFE: chlorotrifluoroethylene

EVE: ethyl vinyl ether

CHVE: cyclohexyl vinyl ether

HBVE: hydroxybutyl vinyl ether

TEA: triethylamine

N-3390: a trade name for a polyisocyanate (Bayer company)

N-75: a trade name for a polyisocyanate (Bayer company)

BAC: butyl acetate

DBTL: dibutyl tin dilaurirate

### Preparation Example 1

A polyacrylate resin was prepared by mixing monomers, solvent, and suitable initiator in various ratios under the conditions shown in Table 1:

TABLE 1

| | Monomer | Amount (g) |
|---|---|---|
| Mixture | MMA | 29.0 |
| | BA | 11.0 |
| | 2-HEMA | 7.0 |
| | MAA | 0.5 |
| | Cardura E10 | 2.5 |

| | |
|---|---|
| Solvent (xylene) | 25.0 |
| Solvent (BAC) | 25.0 |
| Initiator (AIBN) | 1.0 |
| Reaction temperature (° C.) | 110° C. |
| Time (hour) | 8 |
| Solids content (wt %) | 50% |

### Example 1

The polyacrylate resin produced above was reacted with a curing agent in other solvents under the conditions recited in the following Table 2 so as to produce the inventive thermosetting resin:

TABLE 2

| Materials | Example 1 | |
|---|---|---|
| Polyacrylate resin | 46.0 | g |
| Polyisocyanate N-75 | 8.0 | g |
| Toluene | 23.0 | g |
| Butanone | 23.0 | g |
| DBTL (1%) | 0.05 | g |

| | |
|---|---|
| Curing conditions | 80-90° C., 2-3 minutes |

### Preparation Examples 2-3

Fluorocarbon resins were prepared by mixing monomers, solvent, and suitable initiator in different ratios under the conditions shown in Table 3:

TABLE 3

| | | Preparation | Preparation |
|---|---|---|---|
| | | Example 2 | Example 3 |
| Monomers | CTFE | 420 | 325 |
| and amounts | EVE | 136 | 80.8 |
| (g) | CHVE | 106 | 143.6 |
| | HBVE | 79 | 76.7 |

| | | |
|---|---|---|
| Solvent (toluene) | 462 | 394 |
| Initiator (AIBN) | 2.2 | 1.6 |
| TEA | 1.2 | 1.8 |
| Reaction temperature (° C.) | 65 | 65 |
| Reaction time (hour) | 22 | 22 |
| Solids content (wt %) | 60.3 | 59.6 |

### Examples 2-3

The fluorocarbon resins produced above were reacted with a curing agent in other solvents under the conditions recited in the following Table 4:

TABLE 4

| | |
|---|---|
| Example 2 | Example 3 |

| | | | | |
|---|---|---|---|---|
| Fluorocarbon resin | 10 | g | 10 | g |
| Polyisocyanate N-3390 | 1.4 | g | 1.4 | g |
| BAC | 20 | g | 20 | g |
| DBTL(1%) | 0.05 | g | 0.05 | g |

| | | |
|---|---|---|
| Curing conditions | 60° C., 2 hours | 60° C., 2 hours |

### Comparative Example 1

### In the Absence of a Curing Agent

Commercially available thermo-plastic acrylic resin: eterac 7109-X-50 (Eternal company)

### Comparative Example 2

### In the Absence of a Tertiary Carboxylic Ester Monomer and Vinyl Acetate Monomer

Commercially available thermosetting acrylic resin: eterac 7302-XC-60 (Eternal company)

### Comparative Example 3

### In the Absence of a Vinyl Ether Monomer

Commercially available thermosetting fluorocarbon resin: eterflon 4261A (Eternal company)

### Test Methods:

Film Thickness Test: The film thickness of the films of Examples 1 to 3 and comparative examples was measured with a coating thickness gauge (PIM-100, TESA Corporation) under 1 N pressing contact.

Film-forming Property Test: Upon curing, the coating surface is completely dry and cured. The surface is observed to determine whether there is sticking phenomenon. If negative, the film-forming property is good.

Light Transmittance Test: According to JIS K7136 standard method, the test samples were measured for total transmittance (Tt) with a NDH 5000W Haze Meter (Nippon Denshoku Industries Co., Ltd.).

Adhesion Test: Scribing a coating surface with a cross-cut blade, adhering a tape onto the coating surface, tearing the tape at 90°, and determining the peeling off number.

Chemical Resistance Test: The samples were immersed in 10% NaOH for 7 days. After 7 days, the samples were observed for the peeling off of coatings.

Weathering Test: QUV conditions: UV light 313 nm; 60° C.×4 hours +40° C.×4 hours; irradiation time: more than 1000 hours, gloss loss of the coating <60%.

Warp Test: The test samples were cut into level films with 100 mm length×100 mm width, placed in an oven at 120° C. for 10 min, and then taken out and left at room temperature. After being cooled down to the room temperature, the films were measured for warping level on the four corners with a gap gauge, and thereby, the test samples were evaluated for heat-resistant and warp-resistant properties.

### Test Results:

The resins of Examples 1 to 3 were coated on a 1 mm glass substrate. The test results are shown in Table 5:

TABLE 5

| | | | | Comparative | Comparative | Comparative |
|---|---|---|---|---|---|---|
| | Example 1 | Example 2 | Example 3 | Example 1 | Example 2 | Example 3 |
| Film thickness | 10 ± 2 μm | 10 ± 2 μm | 10 ± 2 μm | 10 ± 2 μm | 10 ± 2 μm | 10 ± 2 μm |
| (μm) | | | | | | |
| Film-forming | Good | Good | Good | Good | Good | Good |
| property | | | | | | |
| Light | 95 | 92 | 91 | 88 | 93 | 90 |
| transmittance | | | | | | |
| Adhesion | 100/100 | 100/100 | 100/100 | 0/100 | 30/100 | 20/100 |
| Chemical | Good | Good | Good | Good | Good | Good |
| resistance | | | | | | |
| Weathering | Good | Good | Good | Acceptable | Good | Good |
| property | | | | | | |
| Wrapping test | Good | Good | Good | Poor | Poor | Poor |

What is claimed is:

1. An optical thin sheet having a reinforced structure, comprising
a substrate; and
at least one protective layer, said protective layer formed on at least one of the surfaces of the substrate and comprising an organic layer, wherein the organic layer comprises (a) a thermosetting resin and (b) a curing agent, wherein said thermosetting resin is derived from a monomer mixture comprising the following monomers:
monomer (a1) having at least one thermally curable functional group that does not react with the curing agent, said functional group being selected from the group consisting of hydroxyl, vinyl, amido, urethano, epoxy, and carbonyl and a mixture thereof, and
monomer (a2) having at least one functional group that reacts with the curing agent (b), wherein the functional group is selected from the group consisting of hydroxy, carboxyl, an amino group, and an epoxy group, and a mixture thereof; and
wherein the curing agent (b) possesses at least one functional group that can react with the monomer (a2), wherein said functional group is selected from the group consisting of an isocyanato group, hydroxy, carboxyl, an ester group, an anhydride group, and an amino group, and a mixture thereof.

2. The optical thin sheet of claim 1, wherein the substrate is glass.

3. The optical thin sheet of claim 1, wherein the substrate is a plastic selected from the group consisting of a polyacrylate resin, a polycarbonate resin, a polystyrene resin, a polycycloolefin resin, a polyolefin resin, a cellulose acetate resin, a polyimide resin, and a polyester resin.

4. The optical thin sheet of claim 1, wherein the substrate has a thickness of less than 1 mm.

5. The optical thin sheet of claim 1, wherein the protective layer has a refractive index of from 1.4 to 1.6.

6. The optical thin sheet of claim 1, wherein the protective layer is formed on the surface of the substrate by a method selected from coating, adhesion, vapor-deposition, or spray-deposition.

7. The optical thin sheet of claim 1, wherein the protective layer is composed of an organic layer and has a thickness of from 1 μm to 20 μm.

8. The optical thin sheet of claim 1, wherein the monomer mixture further comprises monomer (a3) selected from a vinyl ether monomer, styrene monomer, a tertiary carboxylic ester, vinyl acetate monomer, or a mixture thereof.

9. The optical thin sheet of claim 1, wherein the thermosetting resin is selected from the group consisting of a polystyrene resin, a polyester resin, an epoxy resin, a fluorocarbon resin, a polyacrylate resin, a polycarbonate, and a mixture thereof.

10. The optical thin sheet of claim 1, wherein the thermosetting resin is a polyacrylate resin.

11. The optical thin sheet of claim 10, wherein the polyacrylate resin is derived from at least one monomer (a1) having the following general formula: 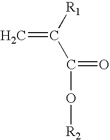
wherein R₁ is hydrogen or methyl; and R₂ is hydrogen, a C₆-C₁₈ aromatic group, a C₁-C₁₈ aliphatic group, or a C₂-C₄ epoxy group.

12. The optical thin sheet of claim 11, wherein the monomer (a1) is selected from the group consisting of (meth)acrylic acid, methyl (meth)acrylate, ethyl (meth)acrylate, (iso-)butyl (meth)acrylate, isooctyl (meth)acrylate, cyclohexyl (meth)acrylate, glycidyl (meth)acrylate, and a mixture thereof.

13. The optical thin sheet of claim 1, wherein the thermosetting resin is a fluorocarbon resin.

14. The optical thin sheet of claim 13, wherein the fluorocarbon resin is derived from at least one monomer (a1) selected from the group consisting of tetrafluoroethylene, hexafluoropropylene, chlorotrifluoroethylene, vinylidene fluoride, fluoroethylene, difluoroethylene, and a mixture thereof.

15. The optical thin sheet of claim 14, wherein the monomer (a1) is chlorotrifluoroethylene.

16. The optical thin sheet of claim 1, wherein the monomer (a2) has a hydroxy functional group.

17. The optical thin sheet of claim 16, wherein the monomer (a2) is selected from the group consisting of hydroxyethyl (meth)acrylate, hydroxypropyl (meth)acrylate, hydroxybutyl vinyl ether, and 2-hydroxyethyl methacrylate and a mixture thereof.

18. The optical thin sheet of claim 1, wherein the curing agent (b) has an isocyanato functional group.

19. The optical thin sheet of claim 1, wherein the organic layer further comprises an additive selected from the group consisting of an anti-static agent, a fluorescent agent, a UV light absorbent, a leveling agent, a solvent, an initiator, a promoter, a wetting agent, a stabilizing agent, and a dispersant.

20. The optical thin sheet of claim 1, having a light transmittance of 90% or more, as determined according to JIS K7136 standard method.

21. An optical thin sheet having a reinforced structure, comprising
a glass substrate with a thickness of less than 1 mm; and
a protective layer coated on a surface of the substrate and composed of an organic layer, wherein the organic layer has a thickness of from 5 μm to 15 μm and comprises (a) a polyacrylate resin and (b) a curing agent with an isocyanato group; wherein the optical thin sheet has a light transmittance of 90% or more, as determined according to JIS K7136 standard method; and the polyacrylate resin is derived from a monomer mixture comprising the following monomers:
monomer (a1) selected from the group consisting of (meth)acrylic acid, methyl (meth)acrylate, ethyl (meth)acrylate, (iso-)butyl (meth)acrylate, isooctyl (meth)acrylate, cyclohexyl (meth)acrylate, glycidyl (meth)acrylate, and a mixture thereof, and
monomer (a2) having a hydroxy group that can react with the curing agent (b).

22. The optical thin sheet of claim 21, wherein the monomer (a2) is selected from the group consisting of hydroxyethyl (meth)acrylate, hydroxypropyl (meth)acrylate, hydroxybutyl vinyl ether, and 2-hydroxyethyl methacrylate and a mixture thereof.

23. The optical thin sheet of claim 21, wherein the curing agent is a diisocyanate.

24. The optical thin sheet of claim 21, wherein the monomer mixture further comprises a tertiary carboxylic ester monomer.

25. The optical thin sheet of claim 21, wherein the organic layer has a refractive index of from 1.4 to 1.6.
